(19) United States
(12) Patent Application Publication
(10) Pub. No.: US 2010/0012751 A1
(43) Pub. Date: Jan. 21, 2010

(54) Laser Assisted Aiming System for Fluid Nozzles

(76) Inventors: Marc R. Warren, Colchester, CT (US); Stephen R. Gardner, Tolland, CT (US)

Correspondence Address: ALIX YALE & RISTAS LLP, 750 MAIN STREET, SUITE 1400, HARTFORD, CT, 06103, US

(21) Appl. No.: 12/460,103

(22) Filed: Jul. 14, 2009

Related U.S. Application Data
(60) Provisional application No. 61/135,158, filed on Jul. 16, 2008.

(51) Int. Cl. B05B 15/00

(52) U.S. Cl. 239/289

(57) ABSTRACT

A laser assisted aiming system for use in directing the flow of a nozzle discharging a fluid stream includes a laser module adapted to emit a light beam that is substantially concentric with the stream of fluid discharged from the discharge tip.

### CROSS-REFERENCE TO RELATED APPLICATIONS

This application claims the benefit under 35 U.S.C. §119(e) of U.S. Provisional Patent Application Ser. No. 61/135,158 filed Jul. 16, 2008.

### BACKGROUND

This disclosure relates to apparatus for aiming fluid nozzles.

A variety of fluids such as liquids and/or gasses are used as a coolant and/or lubricant in machine tool cutting operations, which provide lubricity and remove excess heat produced by the cutting operation. Many of these fluids are liquids are visible to the human eye, and the flow of the fluid may be used to verify the aim of the fluid emitting nozzle. Some fluids, such as compressed air or gas, or “minimum quantity lubrication” (a finely atomized oil carried by a compressed air stream) are either invisible or difficult to see with the human eye, thereby making proper aim problematic. Other systems force the fluid through the nozzle at high pressure, creating an obscuring cloud of mist during operation, again making proper aim difficult, problematic or impossible.

Similarly, a number of fluids/gasses and/or particulate suspensions used in fire suppression systems do not readily provide a means for verifying the aim of nozzles emitting the fire suppression material.

### SUMMARY

There is provided a laser assisted aiming system for use in directing the flow of a nozzle discharging a fluid stream, where the nozzle has an inner passageway and a discharge tip. The system comprises a laser module adapted to emit a light beam that is substantially concentric with the stream of fluid discharged from the discharge tip.

The light beam emitted by the laser module is directed through the nozzle inner passageway and the nozzle discharge tip, and may be substantially concentric with the nozzle.

The system may further comprise a manifold block having opposed first and second sides, with the nozzle being mounted to the first side and the laser module being mounted to the second side. The manifold block includes an inlet and a fluid passage providing communication between the inlet and the nozzle inner passageway.

A substantially optically clear window may be disposed intermediate the laser module and the manifold block fluid passage to protect the laser module from the fluid. A seal element seals the window to the manifold block.

The system may further comprise a cylindrical shield tube disposed concentric to and contiguous with an optical path of the light beam. The seal tube has at least one opening disposed proximate to an end of the tube adjacent to the window.

The system may further comprise a carrier or an end cap mounted to the manifold block, with the carrier or end cap enveloping at least a portion of the laser module.

The system may further comprise an aiming module which includes the laser module and a support tube. The laser module is mounted concentrically within the support tube at a first end of the support tube.

The support tube inner diameter that is greater than the nozzle outer diameter whereby the nozzle may be inserted into a second end of the support tube.

The aiming module may also include a closing device adapted to releasably fasten the support tube to the nozzle.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic view of a first embodiment of a laser assisted aiming system for fluid nozzles;

FIG. 2 is a side view of the system of FIG. 1;

FIG. 3 is a schematic view of a second embodiment of a laser assisted aiming system for fluid nozzles;

FIG. 4 is an enlarged view of the laser module of FIG. 3;

FIG. 5 is an enlarged view of the fluid nozzle tube of FIG. 3;

FIG. 6 is a schematic view of a third embodiment of a laser assisted aiming system for fluid nozzles;

FIG. 7 is a side view of the system of FIG. 6; and

FIG. 8 is a schematic view showing the laser assisted aiming system in use.

### DETAILED DESCRIPTION

The laser assisted aiming systems disclosed herein are suitable for use in directing the discharge of substantially any fluid from a nozzle to a predetermined target or target area. The term “fluid” is hereby defined to be any liquid, gas, or particulate matter suspended in a liquid or gas that may be readily discharged from a conventional nozzle.

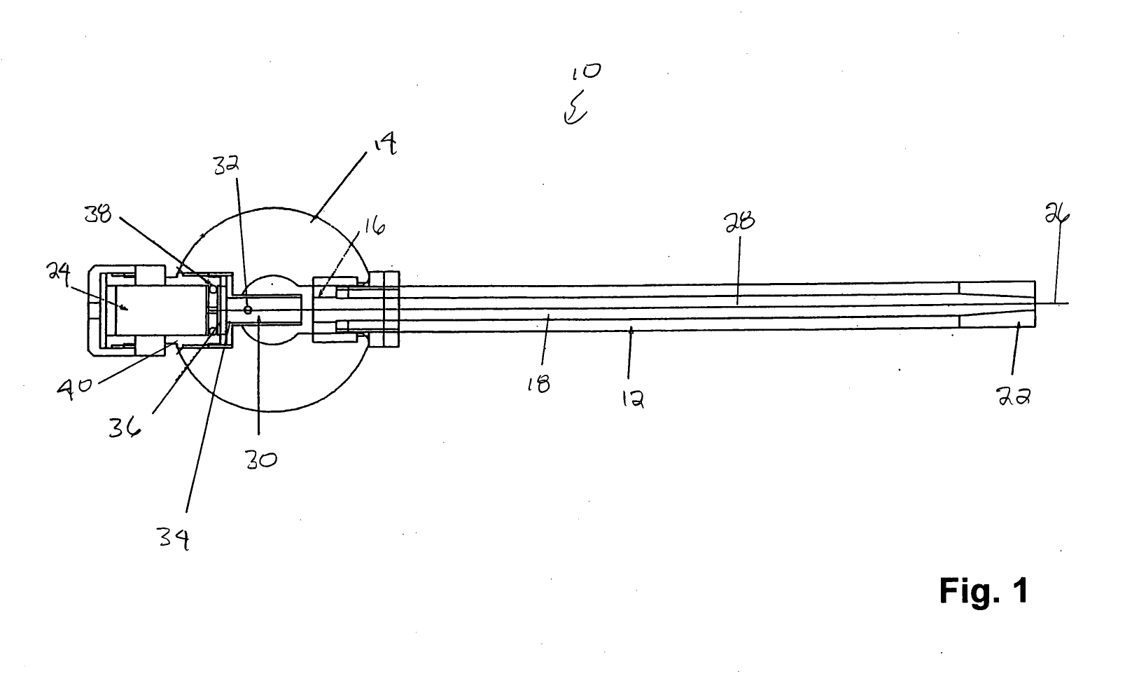

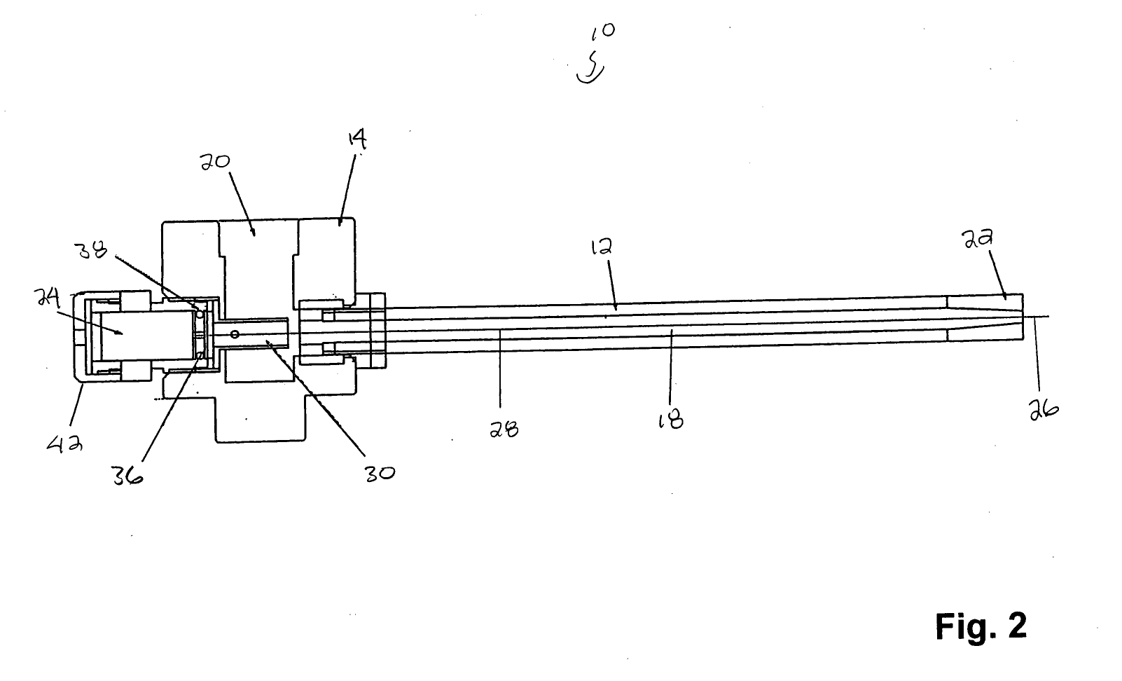

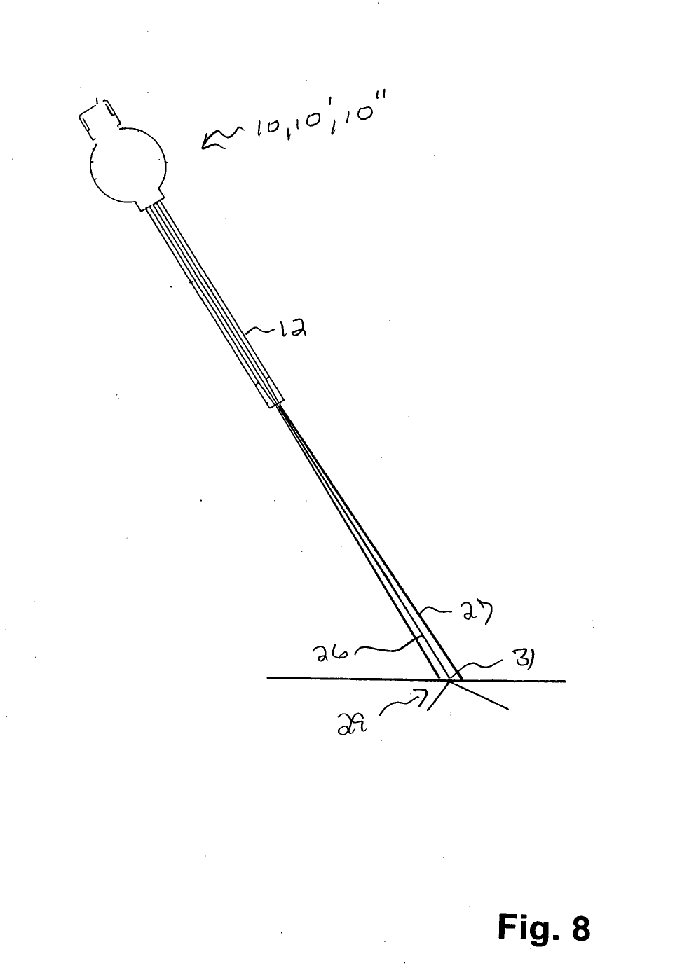

With reference to FIGS. 1 and 2, a first embodiment of a laser assisted aiming system 10 in accordance with the present disclosure includes a nozzle 12 mounted to a manifold block 14. A fluid passage 16 in the manifold block 14 is in communication with the inner passageway 18 of the nozzle 12, such that fluid may pass readily from the manifold block inlet 20, through the fluid passage 16, the nozzle inner passageway 18 and exit through the nozzle tip 22. Mounted on the side of the manifold block 14 opposite the nozzle 12 is a laser module 24 or other illumination source. The laser module 24 is oriented such that the emitted light beam 26 is directed through the nozzle inner passageway 18 and nozzle tip 22. More specifically, the light beam 26 is substantially concentric with the fluid stream 27 as it flows through the nozzle 12 and after the fluid stream 27 is discharged from the nozzle tip 22 (FIG. 8). For example, the light beam 26 may be emitted along the axis 28 of the fluid stream 27. It should be appreciated that the fluid stream 27 discharged from the nozzle 12 may be directed to the target/target area 29 by positioning the “dot” of light 31 created by the light beam 26 on the target/target area 29 during the aiming operation.

A shield tube 30 is mounted concentric to and contiguous with the optical path of the emitted light beam 26. The “shield tube” 30 is a thin-walled tube that is open at both ends. Small diameter cross-holes 32 extend through the wall of the shield tube 30 proximate to the tube end 34 that is near the laser module 24. The laser module 24 is protected from the fluid by an optically clear window 36 and an O-ring seal 38. The laser module 24 is secured in place by a carrier 42 and/or end cap 44 mounted to the manifold block 14 by threading or other means.

The shield tube 30 is mounted contiguously and concentric to the laser module window 36 to assist in clearing the window 36 of condensed liquid so that the light beam focus can be maintained during the aiming operation. Compressed air or other gas can be injected into the fluid passage 16 of the manifold block 14 to clear the laser module window 36 (with the compressed gas flowing through the shield tube cross-holes 32) and nozzle 12 and tip 22 of liquid so that beam focus can be re-established prior to the aiming operation.

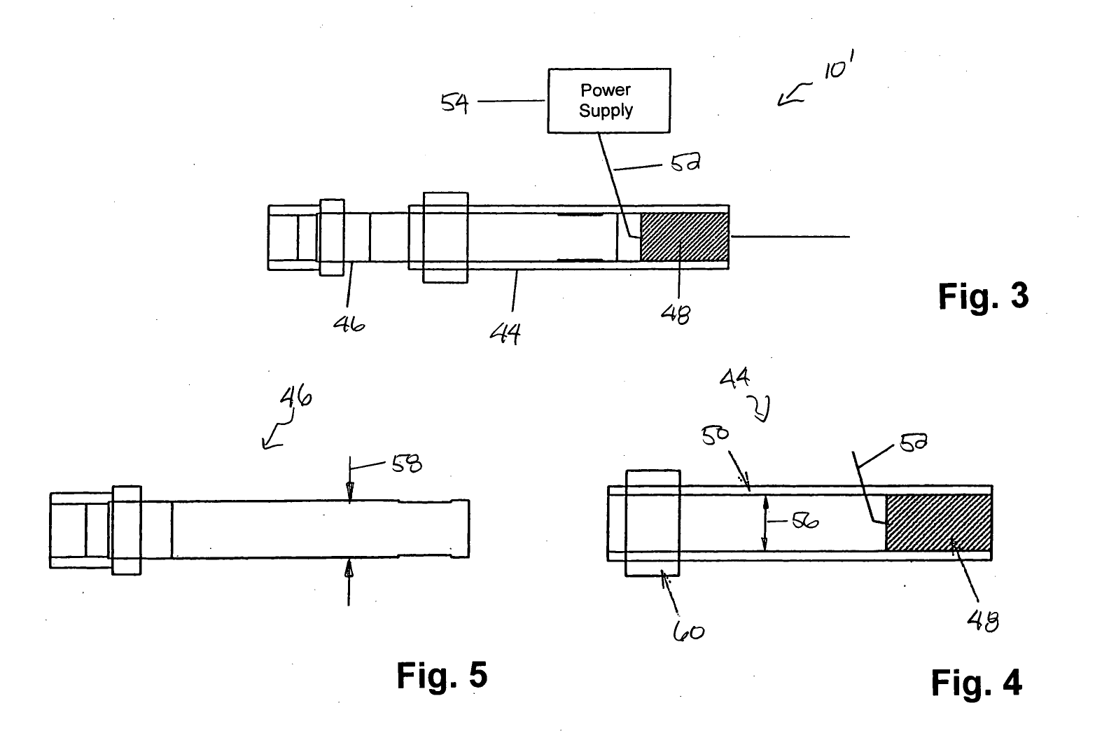

With reference to FIGS. 3-5, a second embodiment of the laser assisted aiming system 10′ is directed to a laser aiming module 44 that may be detachably connected to a nozzle 46 to facilitate aiming the nozzle 46 and then removed from the nozzle 46 before the fluid flow begins. This embodiment comprises a laser module 48 mounted concentrically within a supporting tube 50. The laser module 48 is connected by an insulated electrical wire 52 to an external battery pack or power supply 54. The supporting tube 50 is designed such that the inside diameter 56 is slightly larger than the outside diameter 58 of the nozzle 46 and is equipped with a collet-type closing device 60 to allow the aiming module 44 to be securely fastened to the nozzle 46. For aiming purposes, the laser aiming module 44 is detachably connected to the nozzle 46 by inserting the nozzle 46 into the supporting tube 50 and temporarily locking the aiming module 44 to the nozzle 46 using the closing device 60. The aiming module 44 is removed from the nozzle 46 for actual operation of the nozzle 46 by unlocking the supporting tube 50 and withdrawing the aiming module 44 from the nozzle 46.

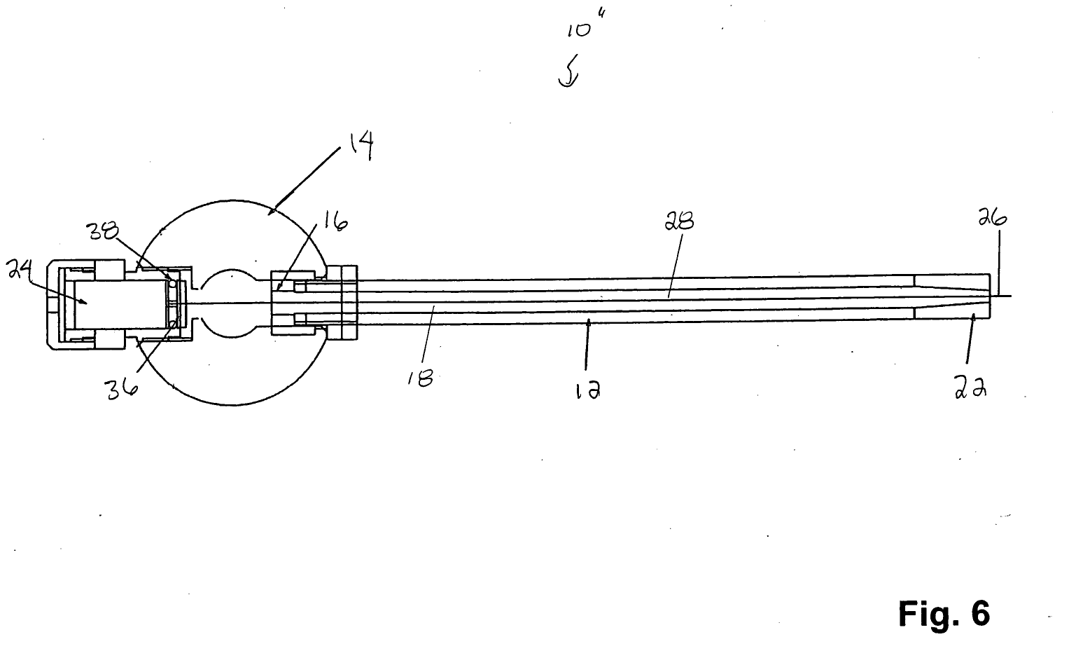

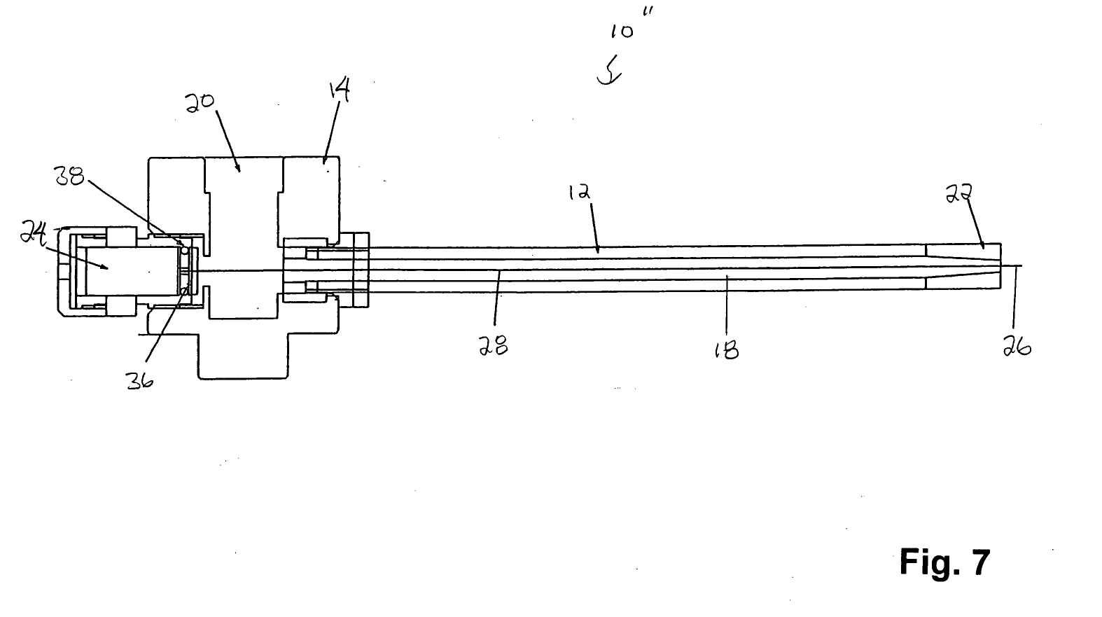

With reference to FIGS. 6 and 7, a third embodiment of the laser assisted aiming system 10″ is similar to embodiment of FIGS. 1 and 2 except that no shield tube is present. In most instances, a shield tube is not required. Fluid and air enter through the fluid inlet 20 and find their way to the nozzle inner passageway 18. This flow also tends to clear window 36 without the use of the shield tube.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A laser assisted aiming system for use in directing the flow of a nozzle discharging a fluid stream, the nozzle defining an inner passageway and having a discharge tip, the system comprising a laser module adapted to emit a light beam that is substantially concentric with the stream of fluid discharged from the discharge tip.

2. The system of claim 1 wherein the light beam emitted by the laser module is directed through the nozzle inner passageway and the nozzle discharge tip.

3. The system of claim 2 wherein the light beam is substantially concentric with the nozzle.

4. The system of claim 1 further comprising a manifold block having opposed first and second sides, the nozzle being mounted to the first side and the laser module being mounted to the second side.

5. The system of claim 4 wherein the manifold block includes an inlet and a fluid passage providing communication between the inlet and the nozzle inner passageway.

6. The system of claim 5 further comprising a substantially optically clear window disposed intermediate the laser module and the manifold block fluid passage.

7. The system of claim 6 further comprising a seal element sealing the window to the manifold block.

8. The system of claim 6 further comprising a cylindrical shield tube disposed concentric to and contiguous with an optical path of the light beam.

9. The system of claim 8 wherein the shield tube defines at least one opening disposed proximate to an end of the tube adjacent to the window.

10. The system of claim 4 further comprising a carrier or an end cap mounted to the manifold block, the carrier or end cap enveloping at least a portion of the laser module.

11. The system of claim 1 further comprising an aiming module including the laser module and a support tube, the laser module being mounted concentrically within the support tube at a first end of the support tube.

12. The system of claim 11 wherein the nozzle has an outer diameter and the support tube has an inner diameter, the support tube inner diameter being greater than the nozzle outer diameter whereby the nozzle may be inserted into a second end of the support tube.

13. The system of claim 12 wherein the aiming module also includes a collet-type closing device adapted to releasably fasten the support tube to the nozzle.

14. A laser assisted aiming system for use in directing the flow of a nozzle discharging a fluid stream, the system comprising:
a manifold block having opposed first and second sides;
a nozzle mounted to the manifold block first side, the nozzle defining an inner passageway and having a discharge tip; and
a laser module mounted to the manifold block second side, the laser module emitting a light beam that is substantially concentric with the nozzle inner passageway, the discharge tip and the stream of fluid discharged from the discharge tip.

15. The system of claim 14 wherein the manifold block includes an inlet and a fluid passage providing communication between the inlet and the nozzle inner passageway.

16. The system of claim 15 further comprising
a substantially optically clear window disposed intermediate the laser module and the manifold block fluid passage; and
a seal element sealing the window to the manifold block.

17. The system of claim 16 further comprising a cylindrical shield tube disposed concentric to and contiguous with an optical path of the light beam, the shield tube defining at least one opening disposed proximate to an end of the tube adjacent to the window.

18. The system of claim 14 further comprising a carrier or an end cap mounted to the manifold block, the carrier or end cap enveloping at least a portion of the laser module.

19. A laser assisted aiming system for use in directing the flow of a nozzle discharging a fluid stream, the nozzle having an outer diameter, the system comprising an aiming module including:
a support tube having oppositely disposed first and second ends; and
a laser module mounted concentrically within the support tube proximate the support tube first end.

20. The system of claim 19 wherein the support tube has an inner diameter that is greater than the nozzle outer diameter whereby the nozzle may be inserted into the support tube second end.

21. The system of claim 20 wherein the aiming module also includes a closing device adapted to releasably fasten the support tube to the nozzle.
